(19) United States
(12) Patent Application Publication
(10) Pub. No.: US 2005/0196716 A1
(43) Pub. Date: Sep. 8, 2005

(54) Artificial flame

(76) Inventors: Dan B. Haab, Springville, UT (US); Vaughn R. Staheli, Payson, UT (US)

Correspondence Address: Vaughn Staheli, 1439 South 600 West, Payson, UT, 84651, US

(21) Appl. No.: 11/071,806

(22) Filed: Mar. 3, 2005

Related U.S. Application Data
(60) Provisional application No. 60/549,827, filed on Mar. 3, 2004.

(51) Int. Cl. F21S 10/04

(52) U.S. Cl. 431/126; 362/810

(57) ABSTRACT

An artificial flame comprising light sources arranged to provide the appearance of a realistic flame. The artificial flame may include a plurality of colored LEDs connectable to a power source and a programmable logic device, microcontroller, or ASIC to generate pseudorandom and/or pulse width modulation to provide an artificial flame with a flickering appearance.

This application claims priority to and the benefit of, and incorporates herein by reference, in its entirety, provisional U.S. patent application Ser. No. 60/549,827, filed Mar. 3, 2004.

### BACKGROUND

Even though fire has been admired by humankind for thousands of years for its warmth and beauty, its use can be hazardous under many conditions. Accordingly, the fire hazard associated with an open flame may limit its use, especially indoors. Accordingly, there exists a need for an artificial flame that is realistic in appearance but lessens the risk of fire hazards.

For example, an artificial flame that looks like a real flame may be used to form an artificial flame for use with a candle. Similarly, a series of artificial flames may be used to create an artificial fire.

### SUMMARY

An artificial flame including multiple Light Emitting Diodes (LEDs) is described herein. A suitable artificial flame may include multiple LEDs arranged in the shape of a flame. A particularly suitable artificial flame may include an arrangement of different colored LEDs arranged to approximate the different colors of a flame. A particularly suitable artificial flame may include the use of a programmable logic device, microcontroller, or ASIC to generate pseudorandom pulses that light up the LEDs in a manner that resembles the flickering appearance of a real flame. Another suitable embodiment may include the use of pulse width modulation of the LED pulses to further enhance the appearance of a flickering flame.

According to another suitable embodiment, at least a portion of the artificial flame may be enveloped in a casing that may enhance the diffusion of the LEDs and/or protect the LEDs.

According to yet another suitable embodiment, a plurality of artificial flames may be used in conjunction to form a series of artificial flames. For example, a series of artificial flames may be used to create an artificial fire, an artificial torch, or artificial flames relating to a candle, candelabra, chandelier, menorah, Christmas tree, or any other use of a flame were fire hazards may be reduced.

### BRIEF DESCRIPTION OF THE FIGURES

FIGS. 1-4 show schematic diagrams of generated waveforms.

FIG. 5 shows a schematic diagram of a programmable logic device, microcontroller, or ASIC.

FIG. 6 shows a schematic diagram of an electrical circuit for an artificial flame.

FIG. 7 shows a schematic diagram of an artificial flame.

### DETAILED DESCRIPTION

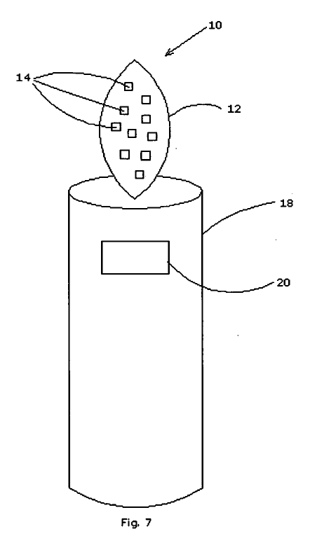

As schematically depicted in FIG. 7, the artificial flame 10 may include a support structure 12 to support a plurality of LEDs 14 each connectable to a power source. The artificial flame 10 may also include a programmable logic device, microcontroller, or ASIC 20 to generate a flickering appearance of the artificial flame 10.

As schematically depicted in FIG. 7, multiple LEDs 14 may be arranged in the shape of a flame to create the appearance of a realistic flame. A suitable artificial flame may include LEDs 14 on more than one side of the support structure 12. A particularly suitable artificial flame may include LEDs arranged to create the appearance of a three dimensional artificial flame.

The artificial flame 10 may include different colors of LEDs 14 (e.g., blue, green, red, orange, yellow, white and/or shades thereof) arranged to create the appearance of a realistic flame. For example, a suitable artificial flame may include blue LEDs at the base of the artificial flame, red and/or orange LEDs toward the middle of the artificial flame, and yellow and/or white LEDs toward the top of the artificial flame. Other arrangements of colored LEDs may be used in an artificial flame to approximate the general appearance of a specific type or kind of flame or special effect such as a flame including substantially one color.

As schematically depicted in FIG. 7, the LEDS 14 may be connectable to a power source. According to a suitable embodiment, the artificial flame may be connectable to DC voltage inputs such as a battery or batteries. According to another suitable embodiment, the artificial flame may be connectable to an AC-DC power supply. According to another suitable embodiment, the artificial flame may employ an AC-DC conversion technique to allow for direct connection to an AC power source. According to a particularly suitable embodiment, the artificial flame may be connectable to an AC power source so that the artificial flame may be placed in a standard bulb base. For example, according to one suitable embodiment, the artificial flame may take the appearance of an artificial candle flame (e.g., an artificial flame supported by a shaft representing a candlestick) and be connectable to a standard bulb base. Other embodiments of an artificial flame may enable a user to connect the artificial flame into an existing electric fixture such as a candelabra, chandelier, menorah, lamp, or other light fixture where the appearance of a flame is desired.

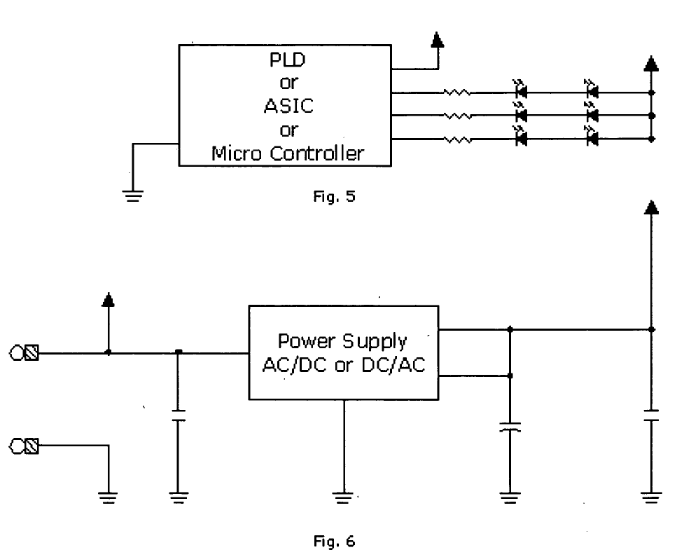

As schematically depicted in FIG. 5, according to a suitable embodiment, the artificial flame may include a programmable logic device, microcontroller, or ASIC 20 to generate a flickering appearance of the artificial flame 10. The programmable logic device, microcontroller, or ASIC 20 may be housed in a housing 18. According to a particularly suitable embodiment, the housing may take on the appearance of a candlestick, menorah, log, torch base, candelabra, stone, pool, stove top, or any other article to which a flame may be associated.

As schematically depicted in FIGS. 3, according to a suitable embodiment a programmable logic device, microcontroller, or ASIC 20 may be used to generate pseudorandom pulses that light up the LEDs to resemble the flickering of a flame. By individually controlling each LED or group of LEDs with the generated pseudorandom pulses, the unique look and feel of a real flame is created. This provides a more realistic flicker compared to simply turning on and off a light source.

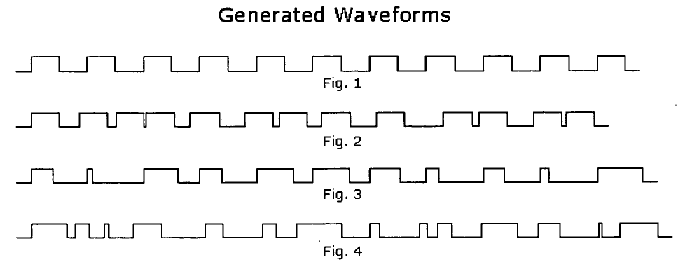

As schematically depicted in FIGS. 1-4, another suitable embodiment the artificial flame may include the use of pulse width modulation of the LED pulses to further enhance the appearance of a flickering flame. The addition of pulse width modulation to each LED or group of LEDs allows for differing degrees of brightness for each LED or group of LEDs. The ability to control the LED or group of LED's brightness further enhances the realistic look and feel of a real flame.

According to a suitable embodiment, at least a portion of the LEDs 14 may be enveloped in a material that may enhance the diffusion of the LED's light. For example, according to a suitable embodiment, a casing 22 may envelop the LEDs. The casing 22 may be formed from glass, plastic or any other material that may diffuse the light and provide a realistic flame appearance. According to a particularly suitable embodiment, the casing 22 may take the shape or form of a flame.

According to a suitable embodiment, a plurality of artificial flames may be used in conjunction to form a series of artificial flames. For example, a series of artificial flames may be used to create the appearance of an artificial fire, an artificial torch, or any article that may require multiple artificial flames.

According to another suitable embodiment, a plurality of artificial flames may be strung together to form a series of artificial flames. For example, a plurality of artificial flames may be used in conjunction to represent multiple artificial flames relating to a candelabra, a menorah, a chandelier, or a string of candles or other plurality of artificial flames for decorative purposes such as Christmas lights or other decorations.

According to a suitable embodiment, the series of artificial flames 10 may be coupled to one or more programmable logic devices, microcontrollers, and/or ASICS. The series of artificial flames 10 may be coupled to a single programmable logic device, microcontroller, or ASIC, or each individual artificial flame 10 in the series may be coupled to a separate programmable logic device, microcontroller, or ASIC. According to another suitable embodiment, the series of artificial flames 10 may be grouped with each group coupled to a programmable logic device, microcontroller, or ASIC.

Additional Illustrative Embodiments

A description of a number of additional illustrative embodiments is provided below. The embodiments described are intended to illustrate the present materials and methods and are not intended to limit their scope.

An artificial flame comprising a support structure, a plurality of LEDs connectable to a power source coupled to the support structure, and a microcontroller wherein the microcontroller generates pseudorandom pulses to cause the LEDs to flicker.

An artificial flame comprising a support structure, a plurality of LEDs connectable to a power source coupled to the support structure, and a programmable logic device wherein the programmable logic device generates pseudorandom pulses to cause the LEDs to flicker.

An artificial flame comprising a support structure, a plurality of LEDs connectable to a power source coupled to the support structure, and an ASIC wherein the ASIC generates pseudorandom pulses to cause the LEDs to flicker.

An artificial flame comprising a support structure, a plurality of LEDs connectable to a power source coupled to the support structure, and one of a microcontroller, programmable logic device, or ASIC wherein the microcontroller, programmable logic device, or ASIC generates pseudorandom pulses and/or pulse width modulation to cause the LEDs to flicker.

An artificial flame comprising an arrangement of colored LEDs in the shape of a flame.

An artificial flame comprising an arrangement of LEDs coupled to more than one side of the support structure.

An artificial flame comprising a support structure and an arrangement of LEDs coupled to the support structure in a manner that provides the appearance of a three dimensional flame.

An artificial flame comprising a support structure, a plurality of LEDs connectable to a DC power source coupled to the support structure, and one of a microcontroller, programmable logic device, or ASIC wherein the microcontroller, programmable logic device, or ASIC generates pseudorandom pulses and/or pulse width modulation to cause the LEDs to flicker.

An artificial flame comprising a support structure, a plurality of LEDs connectable to an AC-DC power source coupled to the support structure, and one of a microcontroller, programmable logic device, or ASIC wherein the microcontroller, programmable logic device, or ASIC generates pseudorandom pulses and/or pulse width modulation to cause the LEDs to flicker.

An artificial flame comprising a support structure, a plurality of LEDs connectable to an AC power source coupled to the support structure, and one of a microcontroller, programmable logic device, or ASIC wherein the microcontroller, programmable logic device, or ASIC generates pseudorandom pulses and/or pulse width modulation to cause the LEDs to flicker.

An artificial flame connectable to a standard bulb base.

An artificial flame in the form of a candle.

An artificial flame in the form of an artificial fire.

An artificial flame in the form of a string of candles.

An artificial flame comprising a support structure, a plurality of LEDs connectable to a DC power source coupled to the support structure, wherein the LEDs are coupled to one of a microcontroller, programmable logic device, or ASIC wherein the microcontroller, programmable logic device, or ASIC generates pseudorandom pulses and/or pulse width modulation to cause the LEDs to flicker.

A series of artificial flames comprising a series of support structures, a plurality of LEDs connectable to a DC power source coupled to the support structures, wherein the LEDs are coupled to more than one microcontroller, programmable logic device, or ASIC wherein the microcontroller, programmable logic device, or ASIC generates pseudorandom pulses and/or pulse width modulation to cause the LEDs to flicker.

An artificial flame comprising a casing at least partially enveloping the LEDs.

An artificial flame comprising a casing in the shape of a flame.

The invention has been described with reference to various specific and illustrative embodiments and techniques. However, it should be understood that many variations and modifications may be made while remaining within the spirit and scope of the invention.

1. An artificial flame comprising:
a support structure,
at least one light source connectable to a power source and responsive to the support structure, and
one of a microcontroller, programmable logic device, or ASIC wherein the microcontroller, programmable logic device, or ASIC generates one of pseudorandom pulses or pulse width modulation to cause the at least one light source to flicker.

2. The artificial flame of claim 1 wherein the at least one light source comprises at least one LED.

3. The artificial flame of claim 1 further comprising a plurality of light sources wherein the plurality of light sources comprise a plurality of LEDs.

4. The artificial flame of claim 1 wherein the at least one light source is responsive to the support structure in a manner that provides the appearance of a three dimensional flame.

5. The artificial flame of claim 1 wherein the power source is a DC power source.

6. The artificial flame of claim 1 wherein the power source is an AC-DC power source.

7. The artificial flame of claim 1 wherein the power source is an AC power source.

8. The artificial flame of claim 1 connectable to a standard bulb base.

9. The artificial flame of claim 3 wherein the plurality of light sources are arranged to take on the appearance of a plurality of flames.

10. The light of claim 9 wherein the plurality of flames are associated with one of a candle, torch, fire, menorah, or candelabra.

11. A light comprising:
at least one support structure, and
a plurality of light sources responsive to the support structure, connectable to a power source, and responsive to at least one of a microcontroller, a programmable logic device, or an ASIC, wherein the microcontroller, programmable logic device, or ASIC generates at least one of pseudorandom pulses or pulse width modulation.

12. The light of claim 11 wherein the plurality of light sources comprise a plurality of LEDs.

13. The light of claim 11 wherein the plurality of light sources are responsive to the support structure in a manner to produce the general appearance of a flame.

14. The light of claim 11 further comprising a casing at least partially enveloping the light sources.

15. The light of claim 14 wherein the casing is formed in the general shape of a flame.

16. The light of claim 11 wherein the plurality of light sources comprise a plurality of colored LEDs.

17. The light of claim 16 wherein the plurality of colored LEDs comprise a plurality of different colors.

18. The light of claim 11 wherein the plurality of light sources are arranged to take on the general appearance of a plurality of flames.

19. The light of claim 17 wherein the light sources are associated with one of a candle, torch, fire, menorah, or candelabra.
